(19) United States
(12) Patent Application Publication
(10) Pub. No.: US 2026/0170321 A1
(43) Pub. Date: Jun. 18, 2026

(54) SCALABLE TIME-DOMAIN PHOTONIC NEURAL NETWORK

(71) Applicant: RTX BBN Technologies, Inc., Cambridge, MA (US)

(72) Inventors: Michael Grace, Watertown, MA (US); Moe D. Soltani, Belmont, MA (US); Milica Notaros, Arlington, MA (US); Richard B. Lazarus, Winchester, MA (US)

(21) Appl. No.: 19/418,575

(22) Filed: Dec. 12, 2025

Related U.S. Application Data
(60) Provisional application No. 63/733,120, filed on Dec. 12, 2024.

(51) Int. Cl. G06N 3/067

(52) U.S. Cl. CPC G06N 3/0675

(57) ABSTRACT

A photonic neural network may include photonic network layers to receive an input time-modulated signal and provide an output time-modulated signal. Each of the photonic network layers may include multiple neurons including a neuron modulator to apply serialized weights to a portion of the input time-modulated signal, an integrating detector to integrate the input time-modulated signal to provide a scalar signal, and a travelling-wave resonator connected to the integrating detector. The layer waveguide may be serially connected to the travelling-wave resonators and may serially perform nonlinear activation of seed light in the layer waveguide based on the scalar signals to generate the output time-modulated signal.

### CROSS-REFERENCE TO RELATED APPLICATION

The present application claims the benefit under 35 U.S.C. § 119(e) of U.S. Provisional Application Ser. No. 63/733,120, filed Dec. 12, 2024, naming Michael Grace, Moe D. Soltani, Milica Notaros and Richard B. Lazarus as inventors, which is incorporated herein by reference in the entirety.

### TECHNICAL FIELD

The present disclosure relates generally to photonic neural networks and, more particularly, to time-domain photonic neural networks.

### BACKGROUND

Deep neural networks are typically large and include many layers (M) with many neurons (N) each, which require M×N² trainable weights. Typical photonic techniques require separate components for each of the trainable weights, which limits scalability. There is therefore a need to develop systems and methods to address the above deficiencies.

### SUMMARY

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

In embodiments, the techniques described herein relate to a photonic neural network including one or more photonic network layers configured to receive an input time-modulated signal and provide an output time-modulated signal, where the input time-modulated signal for each of the one or more photonic network layers corresponds to either a source time-modulated signal received by a first of one or more photonic network layers or the output time-modulated signal from another of the one or more photonic network layers, where each of the one or more photonic network layers includes a plurality of neurons, where each of the plurality of neurons includes a neuron modulator to apply serialized weights to a portion of the input time-modulated signal; an integrating detector to integrate the input time-modulated signal to provide a scalar signal; and a travelling-wave resonator connected to the integrating detector; and a layer waveguide serially connected to the travelling-wave resonators of the plurality of neurons, where the travelling-wave resonators in the plurality of neurons serially perform nonlinear activation of seed light in the layer waveguide based on the scalar signals to generate the output time-modulated signal.

In embodiments, the techniques described herein relate to a photonic neural network, where, for at least one of the one or more photonic network layers, timing of the nonlinear activation of the seed light by the travelling-wave resonators is controlled by electronically delaying the scalar signals to the travelling-wave resonators.

In embodiments, the techniques described herein relate to a photonic neural network, where, for at least one of the one or more photonic network layers, timing of the nonlinear activation of the seed light by the travelling-wave resonators is controlled by sequentially tuning a resonant wavelength of the travelling-wave resonators to match a wavelength of the seed light in the layer waveguide.

In embodiments, the techniques described herein relate to a photonic neural network, where timing of the nonlinear activation of the seed light by the travelling-wave resonators is adjustable to reconfigure at least one of the one or more photonic network layers.

In embodiments, the techniques described herein relate to a photonic neural network, where, timing of the nonlinear activation of the seed light by the travelling-wave resonators is adjustable to adjust connectivity between at least two of the photonic network layers, to selectively activate or deactivate at least one of neurons in at least one of the photonic network layers, or to perform diagnostic testing of the photonic neural network.

In embodiments, the techniques described herein relate to a photonic neural network, where the neuron modulator in at least one of the one or more photonic network layers includes an electro-optic modulator.

In embodiments, the techniques described herein relate to a photonic neural network, where the integrating detector in at least one of the one or more photonic network layers includes a photodiode.

In embodiments, the techniques described herein relate to a photonic neural network, where the travelling-wave resonator in at least of the plurality of neurons in at least one of the one or more photonic network layers includes at least one of a ring resonator or a racetrack resonator.

In embodiments, the techniques described herein relate to a photonic neural network, where the nonlinear activation corresponds to a nonlinear ReLU (rectified linear unit) activation function.

In embodiments, the techniques described herein relate to a photonic neural network including a laser source configurated to generate seed light; an input splitter to split the seed light into a network waveguide and a seed waveguide; an input modulator to modulate the seed light in the network waveguide to provide a source time-modulated signal; and one or more photonic network layers configured to receive an input time-modulated signal and provide an output time-modulated signal, where the input time-modulated signal for each of the one or more photonic network layers corresponds to either the source time-modulated signal received by a first of the one or more photonic network layers or the output time-modulated signal from another of the one or more photonic network layers, where each of the one or more photonic network layers includes a plurality of neurons, where each of the plurality of neurons includes a neuron modulator to apply serialized weights to a portion of the input time-modulated signal; an integrating detector to integrate the input time-modulated signal to provide a scalar signal; and a travelling-wave resonator connected to the integrating detector; and a layer waveguide serially connected to the travelling-wave resonators of the plurality of neurons, where the travelling-wave resonators serially perform nonlinear activation of the seed light in the layer waveguide based on the scalar signals to generate the output time-modulated signal.

In embodiments, the techniques described herein relate to a photonic neural network, where, for at least one of the one or more photonic network layers, timing of the nonlinear activation of the seed light by the travelling-wave resonators is controlled by electronically delaying the scalar signals to the travelling-wave resonators.

In embodiments, the techniques described herein relate to a photonic neural network, where, for at least one of the one or more photonic network layers, timing of the nonlinear activation of the seed light by the travelling-wave resonators is controlled by sequentially tuning a resonant wavelength of the travelling-wave resonators to match a wavelength of the seed light in the layer waveguide.

In embodiments, the techniques described herein relate to a photonic neural network, where timing of the nonlinear activation of the seed light by the travelling-wave resonators is adjustable to reconfigure at least one of the one or more photonic network layers.

In embodiments, the techniques described herein relate to a photonic neural network, where the neuron modulator in at least one of the one or more photonic network layers includes an electro-optic modulator.

In embodiments, the techniques described herein relate to a photonic neural network, where the input modulator includes an electro-optic modulator.

In embodiments, the techniques described herein relate to a photonic neural network, where the integrating detector in at least one of the one or more photonic network layers includes a photodiode.

In embodiments, the techniques described herein relate to a photonic neural network, where the travelling-wave resonator in at least of the plurality of neurons in at least one of the one or more photonic network layers includes at least one of a ring resonator or a racetrack resonator.

In embodiments, the techniques described herein relate to a photonic neural network, where the nonlinear activation corresponds to a nonlinear ReLU (rectified linear unit) activation function.

In embodiments, the techniques described herein relate to a method including generating, with one or more photonic network layers, an output time-modulated signal from an input time-modulated signal by applying, with a plurality of neuron modulators, serialized weights to portions of the input time-modulated signal; integrating, with a plurality of integrating detectors, the portions of the input time-modulated signal to generate scalar signals; and performing, with a plurality of travelling-wave resonators coupled to the plurality of integrating detectors and a layer waveguide, nonlinear activation of seed light in the layer waveguide based on the scalar signals to provide the output time-modulated signal.

In embodiments, the techniques described herein relate to a method, further including adjusting timing of the nonlinear activation of the seed light by the travelling-wave resonators to reconfigure at least one of the one or more photonic network layers.

### BRIEF DESCRIPTION OF DRAWINGS

The numerous advantages of the disclosure may be better understood by those skilled in the art by reference to the accompanying figures.

FIG. 1A illustrates a block diagram of a photonic neural network, in accordance with one or more embodiments of the present disclosure.

FIG. 1B illustrates a schematic of a photonic neural network in which the timing of the nonlinear activation of the seed light by the travelling-wave resonators is controlled by electronically delaying the scalar signals to the travelling-wave resonators, in accordance with one or more embodiments of the present disclosure.

FIG. 1C illustrates a schematic of a photonic neural network in which the timing of the nonlinear activation of the seed light by the travelling-wave resonators is controlled by sequentially tuning a resonant wavelength of the travelling-wave resonators.

FIG. 1D further schematically depicts the seed light in the layer waveguide as a pulse with constant amplitude and the output time-modulated signal indicating different amplitudes associated with different bits based on the nonlinear activation of different voltages of the scalar signals in the three neurons.

FIG. 2 illustrates a plot of transmitted power of the seed light as a function of applied voltage associated with the scalar signal, in accordance with one or more embodiments of the present disclosure.

FIG. 3 is a flow diagram illustrating steps performed in a method providing time-domain photonic neural networking, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing a photonic neural network operating on time-modulated signals (e.g., serialized signals).

In embodiments, a photonic neural network includes one or more photonic network layers (e.g., a positive integer M photonic network layers), each including a plurality of neurons (e.g., a positive integer N neurons). Each photonic network layer may split an input time-modulated signal to each of the associated neurons. Each neuron may include an optical modulator to apply serialized weights to the input time-modulated signal, and an integrating detector to integrate the input time-modulated signal into a scalar signal, and a travelling-wave resonator. The travelling-wave resonators in each of the neurons of a photonic network layer are serially coupled with a layer waveguide that provides seed light. In this configuration, the travelling-wave resonators associated with the various neurons may provide serial non-linear activation of the seed light in the layer waveguide to produce an output time-domain signal. This process may be repeated for any number (M) of layers, where the output time-domain signal from one layer is used as the input time-domain signal of another layer.

It is contemplated herein that the systems and methods disclosed herein provide a highly-scalable photonic network based on time-multiplexing. For example, the systems and methods disclosed herein may be suitable for implementing highly-efficient neural network architectures including fully connected neural network layers, where each neuron in a layer j may be connected to each neuron in a subsequent layer j+1. In this configuration, the systems and methods disclosed herein may enable a photonic neural network with M×N components (e.g., M layers, each with N neurons operating in parallel on an input time-modulated signal), which provides substantial scalability enhancement over traditional systems that require M×N² components. However, the systems and methods disclosed herein are not limited to fully connected networks and may incorporate any architecture with any connections between neurons of subsequent layers. For example, a sparser network may be implemented by manipulating weights applied to neurons in any of the layers (e.g., by setting weights applied to some neurons to zero). In this way, any examples herein depicting fully connected neural networks are merely illustrative and not limiting on the scope of the present disclosure.

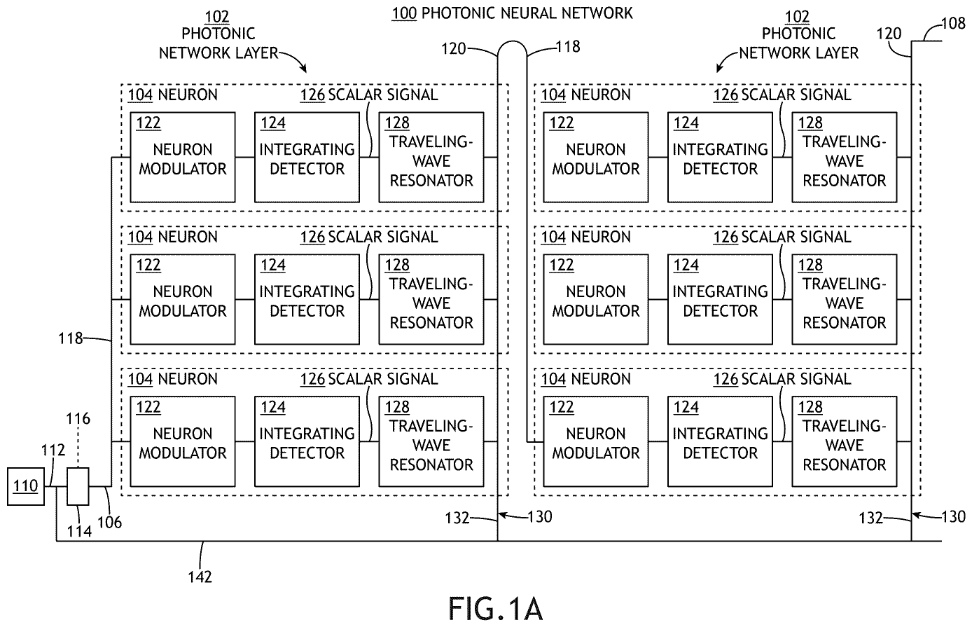

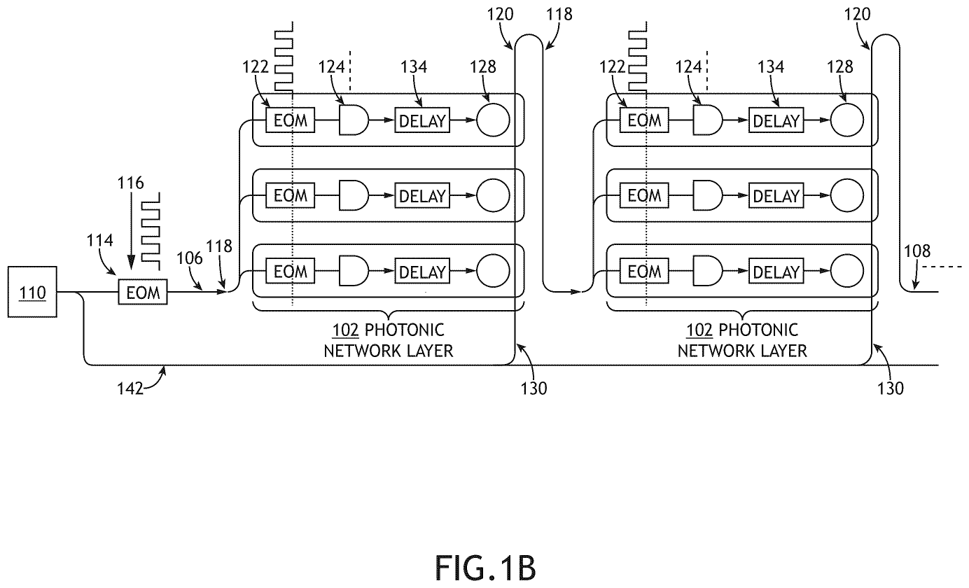

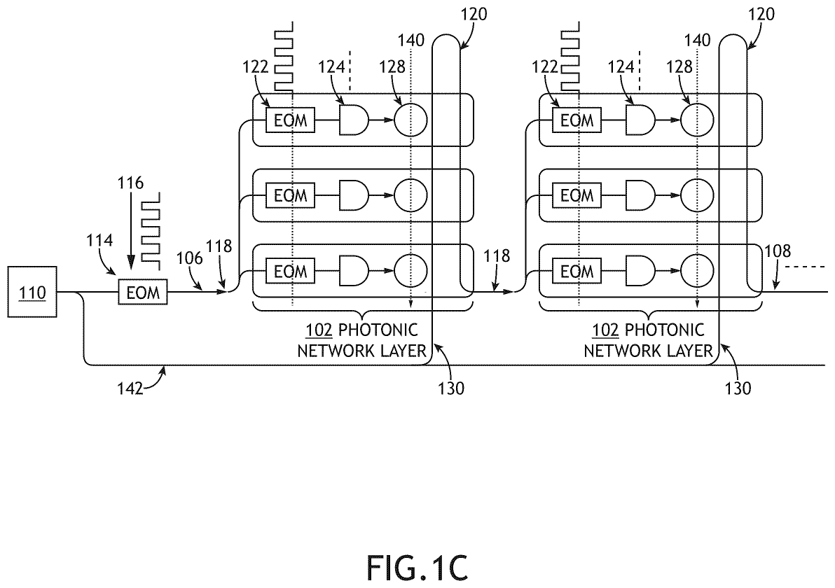

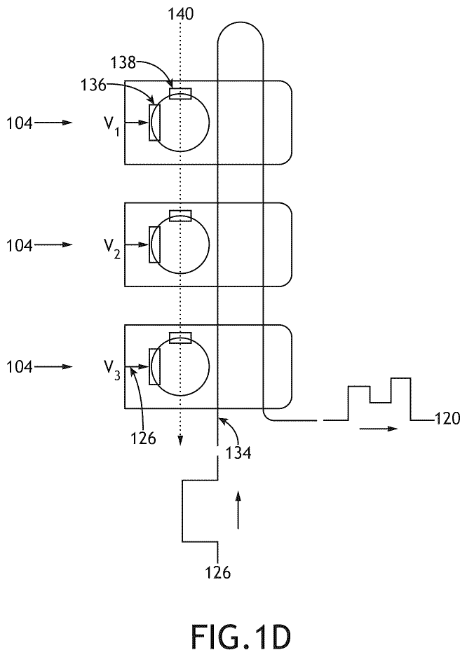

FIG. 1A illustrates a block diagram of a photonic neural network 100, in accordance with one or more embodiments of the present disclosure.

In some embodiments, a photonic neural network 100 includes one or more photonic network layers 102, where each photonic network layer 102 includes a plurality of neurons 104. For example, FIG. 1A depicts a photonic neural network 100 with two photonic network layers 102, each having three neurons 104. However, this is merely an illustration. The photonic neural network 100 may include any number of layers (e.g., any positive integer M), where each photonic network layer 102 may include any number of neurons 104 (e.g., any positive integer N). Further, the various photonic network layers 102 within a photonic neural network 100 may have the same number of neurons 104 or different numbers of neurons 104. Further, the various photonic network layers need not be fully connected. In this way, the photonic neural network 100 may have any desired neural network architecture and the depiction in FIG. 1A is merely illustrative and not limiting on the scope of the present disclosure.

The photonic neural network 100 may receive a source time-modulated signal 106 (e.g., a serialized signal, a time multiplexed signal, or the like) and provide a processed time-modulated signal 108. In this way, the photonic neural network 100 may operate on time-modulated signals and may be referred to as a time-domain photonic neural network.

The source time-modulated signal 106 may be provided to the photonic neural network 100 as an input or may be generated by the photonic neural network 100 in response to serialized electronic input signal.

For example, FIG. 1A depicts a laser source 110 configured to generate input laser light 112 and an input optical modulator 114 configured to modulate the input laser light 112 in response to a serialized electronic input signal 116. The serialized electronic input signal 116 may be generated by any source. For example, in an image or video processing application, a sensor (e.g., a focal plane array, or the like) may natively generate a serialized electronic input signal 116 suitable for use with a photonic neural network 100 as disclosed herein, but often include deserialization components to generate an image or a video frame. However, the systems and methods disclosed herein may operate directly on the serialized data without the need for deserialization components.

As another example, the photonic neural network 100 may receive the source time-modulated signal 106 as an optical signal from an external source.

Each photonic network layer 102 may receive an input time-modulated signal 118 and provide an output time-modulated signal 120. When multiple photonic network layers 102 are present, the output time-modulated signal 120 from one photonic network layer 102 may be provided as an input time-modulated signal 118 for a subsequent photonic network layer 102. Further, the input time-modulated signal 118 for the first photonic network layer 102 may correspond to the source time-modulated signal 106 and the output time-modulated signal 120 from the laser photonic network layer 102 may correspond to the processed time-modulated signal 108.

The various neurons 104 within a photonic network layer 102 may process an associated input time-modulated signal 118 in parallel. For example, the input time-modulated signal 118 may be split (e.g., by one or more splitters) or fanned out to each of the neurons 104 within a photonic network layer 102 such that each neuron 104 receives a portion of the input time-modulated signal 118.

In embodiments, each neuron 104 includes a neuron modulator 122 to apply serialized weights to the respective portion of the input time-modulated signal 118 and an integrating detector 124 to integrate (e.g., sum) the weighted input time-modulated signal 118 to generate a scalar signal 126. For example, the neuron modulator 122 may be synchronized to the input time-modulated signal 118 and may apply weights (e.g., amplitude variations) to the input time-modulated signal 118 at a bit rate of the input time-modulated signal 118. The scalar signal 126 generated by the integrating detector 124 may then have a value corresponding to a sum of the bits in the input time-modulated signal 118.

The neuron modulator 122 may include any optical modulator suitable for serially adjusting an amplitude of the input time-modulated signal 118 to apply weights to the input time-modulated signal 118 including, but not limited to, an electro-optic modulator. The integrating detector 124 may include any type of detector suitable for integrating the weighted input time-modulated signal 118 such as, but not limited to, a photodiode.

In embodiments, each neuron 104 further includes a travelling-wave resonator 128 coupled to both the integrating detector 124 and a layer waveguide 130 providing seed light 132, where the travelling-wave resonator 128 includes one or more modulators to tune a resonant frequency of the traveling-wave resonator 128. In this way, the travelling-wave resonator 128 may operate as an intensity modulator to modulate the seed light 132 in the layer waveguide 130. For example, the scalar signal 126 from the integrating detector 124 may provide a voltage to be applied to a modulator (e.g., a PN junction, a thermal modulator, or the like) on the travelling-wave resonator 128, where the value of the scalar signal 126 may control a transmitted power of the seed light 132 in the layer waveguide 130 and thus apply a modulation to the seed light 132. The seed light 132 provided to the neurons 104 in each layer may be continuous-wave or may be pulsed with a constant amplitude for a duration associated with a duration of the input time-modulated signal 118.

As an illustration, if a resonance frequency of a travelling-wave resonator 128 is near a wavelength of the seed light 132 in the layer waveguide 130, the scalar signal 126 applied to a modulator of the travelling-wave resonator 128 may weakly shift a resonance wavelength of the travelling-wave resonator 128, which may impact the amplitude of the light in the layer waveguide 130. For example, a resonance frequency of the travelling-wave resonator 128 may be initially tuned to a wavelength of the seed light 132 in the layer waveguide 130 such that applying a voltage corresponding to the value of the scalar signal 126 to a modulator may shift the resonance frequency away from the wavelength of the seed light 132 and thus increase the transmitted power by decreasing coupling to the travelling-wave resonator 128. As another example, a resonance frequency of the travelling-wave resonator 128 may be initially tuned slightly away from a wavelength of the seed light 132 in the layer waveguide 130 such that applying a voltage corresponding to the value of the scalar signal 126 to a modulator may shift the resonance frequency towards the wavelength of the seed light 132 and thus decrease the transmitted power by increasing coupling to the travelling-wave resonator 128.

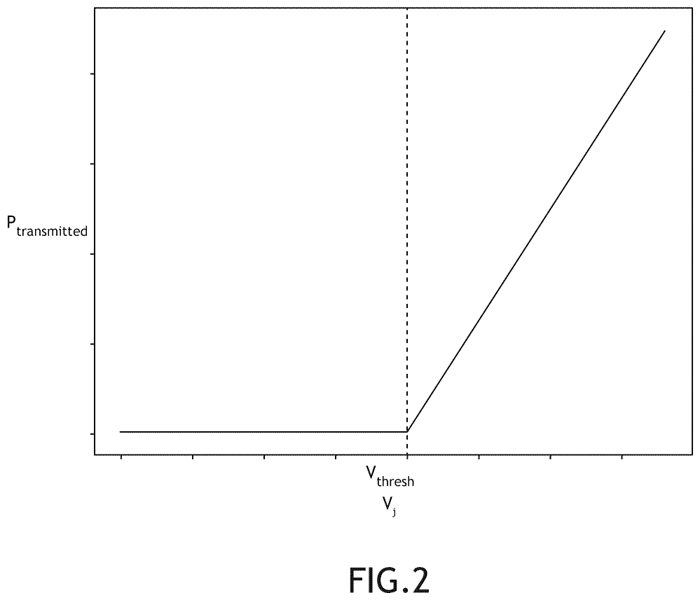

FIG. 2 illustrates a plot of transmitted power (P_{transmitted}) of the seed light 132 as a function of applied voltage (Vⱼ) associated with the scalar signal 126, in accordance with one or more embodiments of the present disclosure. It is contemplated herein that the transmitted power may be low (or zero) for voltages lower than a threshold voltage (Vₜₕᵣₑₛₕ) and may increase above this threshold voltage. In some embodiments, the travelling-wave resonator 128 implements a nonlinear ReLU (rectified linear unit) activation function on the seed light 132 based on the value of the scalar signal 126.

The travelling-wave resonator 128 may be formed as any type of resonator suitable for applying any type of nonlinear activation function on the seed light 132. For example, the travelling-wave resonator 128 may be formed as, but is not limited to, a ring resonator or a racetrack resonator.

Referring again to FIG. 1A, the layer waveguide 130 may be serially coupled to the travelling-wave resonators 128 in each of the neurons 104 in the photonic network layer 102. As a result, the neurons 104 may serially modulate the seed light 132 based on the nonlinear activation of the scalar signals 126 in the various neurons 104 to generate the output time-modulated signal 120 for that travelling-wave resonator 128. As described previously herein, this output time-modulated signal 120 may then be provided as an input time-modulated signal 118 to another photonic network layer 102 or output as the processed time-modulated signal 108 of the photonic neural network 100 as a whole.

Referring now to FIGS. 1B-1D, various nonlimiting embodiments for controlling the timing of the neurons 104 are described, in accordance with one or more embodiments of the present disclosure. In some embodiments, the purpose of controlling the timing is to re-serialize the data processed by a given neural network layer for further time-domain processing (e.g., by a subsequent time-multiplexed neural network layer).

The neurons 104 may control the timing of the serial modulation of the seed light 132 using any suitable technique.

FIG. 1B illustrates a schematic of a photonic neural network 100 in which the timing of the nonlinear activation of the seed light 132 by the travelling-wave resonators 128 is controlled by electronically delaying the scalar signals 126 to the travelling-wave resonators 128, in accordance with one or more embodiments of the present disclosure. For example, FIG. 1B depicts electronic delays 134 in each of the neurons 104 to control the modulation timing of each neuron 104. In this configuration, each travelling-wave resonator 128 may be weakly detuned from the wavelength of the seed light 132 in the layer waveguide 130.

FIG. 1C illustrates a schematic of a photonic neural network 100 in which the timing of the nonlinear activation of the seed light 132 by the travelling-wave resonators 128 is controlled by sequentially tuning a resonant wavelength of the travelling-wave resonators 128. For example, the travelling-wave resonators 128 may be initially strongly detuned from the wavelength of the light in the layer waveguide 130. Timing signals may then be applied to additional modulators (e.g., PN junctions, thermal modulators, or the like) on the travelling-wave resonators 128 to sequentially adjust the resonance frequency to be only weakly detuned (e.g., as described with respect to FIG. 1B). Accordingly, the scalar signals 126 may further tune the resonance frequencies of the travelling-wave resonators 128 to provide the nonlinear activation.

It is contemplated herein that the photonic neural network 100 may be reconfigurable through manipulation of the timing of the neurons 104 in any of the photonic network layers 102. In particular, the neurons 104 in any of the photonic network layers 102 and/or layer-to-layer connectivity may be reconfigurable. For example, signals (e.g., timing signals) that are used to control the serial nonlinear activation of the of the seed light 132 in the neurons 104 may be reconfigured to change a pattern in which the outputs of the neurons 104 are arranged in the output time-modulated signal 120. Non-limiting examples of such reconfigurability include, but are not limited to, changing the neuron connectivity from one layer to the next, implementing neuron drop-out procedures during hardware-in-the-loop neural network training (e.g., selectively activating or de-activating any of the neurons 104), or performing diagnostic testing of the photonic hardware.

FIG. 1D illustrates a schematic of a portion of the photonic neural network 100 in FIG. 1C depicting the modulation of the seed light 132, in accordance with one or more embodiments of the present disclosure. In particular, FIG. 1D depicts modulators 136 controlled by the scalar signals 126 (shown as voltages V₁, V₂, and V₃) along with the additional modulators 138 that are controlled by timing signals 140. In this way, the modulators 136 and the additional modulators 138 may work together to control the resonance frequencies of the associated travelling-wave resonators 128 to provide nonlinear activation and modulation of the seed light 132. FIG. 1D further schematically depicts the seed light 132 in the layer waveguide 130 as a pulse with constant amplitude and the output time-modulated signal 120 indicating different amplitudes associated with different bits based on the nonlinear activation of different voltages of the scalar signals 126 in the three neurons 104. However, this is merely illustrative and not intended to be limiting on the scope of the present disclosure. As described previously herein, the seed light 132 may be pulsed or continuous. Further, a photonic network layer 102 may include any number of layers. It is further contemplated herein that the description of FIG. 1D may be extended to the photonic neural network 100 in FIG. 1B by the removal of the additional modulators 138, where the scalar signals 126 are electronically delayed.

Different photonic network layers 102 may utilize the same or different approaches for controlling the timing of the modulation to generate the associated output time-modulated signals 120. In this way, any of the approaches depicted in FIGS. 1B-1C may be, but is not required to be, applied to at least one photonic network layer 102.

Referring generally to FIGS. 1A-1D, various additional aspects of time-series photonic neural networks are described in greater detail, in accordance with one or more embodiments of the present disclosure.

In some embodiments, the number of active neurons 104 in a photonic network layer 102 may be adjusted or adjustable. For example, one or more neurons 104 in a photonic network layer 102 may be deactivated by not providing weight signals to the associated neuron modulator 122 and/or timing signals 140 to the additional modulators 138 in the configuration of FIG. 1C.

In some embodiments, one or more photonic network layers 102 are reused. For example, the output time-modulated signal 120 from a photonic network layer 102 may be looped (e.g., by an additional waveguide) back and provided as an input time-modulated signal 118 to the same photonic network layer 102. This process may be repeated any number of times, potentially with different numbers of activated neurons 104. It is contemplated herein that such a configuration may provide additional scalability by further reducing the total number of components in the photonic neural network 100. Further, the photonic neural network 100 may include one or more amplifiers to amplify light (e.g., an input time-modulated signal 118, an output time-modulated signal 120, or the like) as needed to mitigate loss through the system.

The seed light 132 for each photonic network layer 102 may be provided by any source. In some embodiments, as illustrated in FIGS. 1A-1C, the seed light 132 for all or some of the photonic network layers 102 is generated by the same laser source 110 that provides the input laser light 112 to an input optical modulator 114. For example, the photonic neural network 100 may include a splitter to direct a portion of the input laser light 112 to a seed waveguide 142, which may be coupled to the various layer waveguides 122 (e.g., via additional splitters). In some embodiments, though not explicitly illustrated, the seed light 132 for one or more of the photonic network layers 102 may be generated by one or more additional laser sources.

The photonic neural network 100, or any portion thereof, may operate at any bitrate compatible with the neuron modulators 122 or other components. For example, the bitrate in any photonic network layer 102 may be limited only by the ability of the neuron modulators to apply serialized weights to the associated input time-modulated signals 118.

Further, each of the photonic network layers 102 may modulate an associated output time-modulated signal 120 at any bit rate. In this way, the bit rate of data flowing through the photonic neural network 100 may either be constant or may change between photonic network layers 102. For example, the bit rate may change between photonic network layers 102 to provide features such as, but not limited to, data compression or to match an output bit rate to a subsequent system that may receive the processed time-modulated signal 108 (or an electronic version thereof).

Any combination of the components of the photonic neural network 100 may be provided as a photonic integrated circuit (PIC) including, but not limited to, the neuron modulators 122, the integrating detectors 124, the travelling-wave resonators 128, or the layer waveguides 122, the seed waveguide 142, the input optical modulator 114, or the laser source 110. In some embodiments, all components are provided in a PIC device. In some embodiments, some portions of the photonic neural network 100 are provided as a PIC device, while some components are provided externally. For example, the laser source 110 may be provided as an external component.

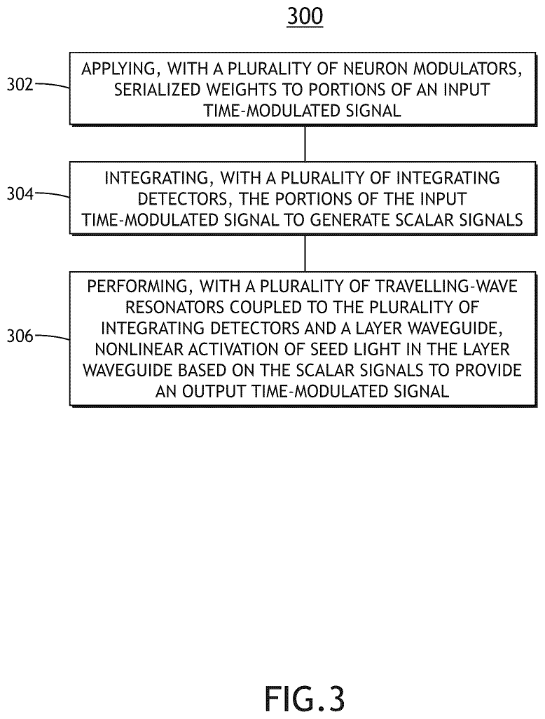

FIG. 3 is a flow diagram illustrating steps performed in a method 300 providing time-domain photonic neural networking, in accordance with one or more embodiments of the present disclosure. The embodiments and enabling technologies described previously herein in the context of the photonic neural network 100 should be interpreted to extend to the method 300. It is further noted, however, that the method 300 is not limited to the architecture of the photonic neural network 100.

The method 300 may include a step 302 of applying, with a plurality of neuron modulators 122, serialized weights to portions of an input time-modulated signal 118. For example, the neuron modulators 122 may each be associated with different neurons 104 in a photonic network layer 102 of a photonic neural network 100.

The method 300 may include a step 304 of integrating, with a plurality of integrating detectors 124, the portions of the input time-modulated signal 118 to generate scalar signals 126. For example, the scalar signals 126 may correspond to voltages associated with a sum of the portions of the input time-modulated signal 118 in the respective neurons 104.

The method 300 may include a step 306 of performing, with a plurality of travelling-wave resonators 128 coupled to the plurality of integrating detectors 124 and a layer waveguide 130, nonlinear activation of seed light 132 in the layer waveguide 130 based on the scalar signals 126 to provide an output time-modulated signal 120.

The steps 302-306 of the method 300 may then be performed any number of times (e.g., by any number of photonic network layers 102). For example, the output time-modulated signal 120 from one iteration of the method 300 may be applied as an input time-modulated signal 118 to another iteration of the method 300. In this way, the method 300 may correspond to steps performed by a photonic network layer 102 of a photonic neural network 100.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A photonic neural network comprising:
one or more photonic network layers configured to receive an input time-modulated signal and provide an output time-modulated signal, wherein the input time-modulated signal for each of the one or more photonic network layers corresponds to either a source time-modulated signal received by a first of one or more photonic network layers or the output time-modulated signal from another of the one or more photonic network layers, wherein each of the one or more photonic network layers comprises:
a plurality of neurons, wherein each of the plurality of neurons comprises:
a neuron modulator to apply serialized weights to a portion of the input time-modulated signal;
an integrating detector to integrate the input time-modulated signal to provide a scalar signal; and
a travelling-wave resonator connected to the integrating detector; and
a layer waveguide serially connected to the travelling-wave resonators of the plurality of neurons, wherein the travelling-wave resonators in the plurality of neurons serially perform nonlinear activation of seed light in the layer waveguide based on the scalar signals to generate the output time-modulated signal.

2. The photonic neural network of claim 1, wherein, for at least one of the one or more photonic network layers, timing of the nonlinear activation of the seed light by the travelling-wave resonators is controlled by electronically delaying the scalar signals to the travelling-wave resonators.

3. The photonic neural network of claim 1, wherein, for at least one of the one or more photonic network layers, timing of the nonlinear activation of the seed light by the travelling-wave resonators is controlled by sequentially tuning a resonant wavelength of the travelling-wave resonators to match a wavelength of the seed light in the layer waveguide.

4. The photonic neural network of claim 1, wherein timing of the nonlinear activation of the seed light by the travelling-wave resonators is adjustable to reconfigure at least one of the one or more photonic network layers.

5. The photonic neural network of claim 4, wherein, timing of the nonlinear activation of the seed light by the travelling-wave resonators is adjustable to adjust connectivity between at least two of the photonic network layers, to selectively activate or deactivate at least one of neurons in at least one of the photonic network layers, or to perform diagnostic testing of the photonic neural network.

6. The photonic neural network of claim 1, wherein the neuron modulator in at least one of the one or more photonic network layers comprises an electro-optic modulator.

7. The photonic neural network of claim 1, wherein the integrating detector in at least one of the one or more photonic network layers comprises a photodiode.

8. The photonic neural network of claim 1, wherein the travelling-wave resonator in at least of the plurality of neurons in at least one of the one or more photonic network layers comprises at least one of a ring resonator or a racetrack resonator.

9. The photonic neural network of claim 1, wherein the nonlinear activation corresponds to a nonlinear ReLU (rectified linear unit) activation function.

10. A photonic neural network comprising:
a laser source configurated to generate seed light;
an input splitter to split the seed light into a network waveguide and a seed waveguide;
an input modulator to modulate the seed light in the network waveguide to provide a source time-modulated signal; and
one or more photonic network layers configured to receive an input time-modulated signal and provide an output time-modulated signal, wherein the input time-modulated signal for each of the one or more photonic network layers corresponds to either the source time-modulated signal received by a first of the one or more photonic network layers or the output time-modulated signal from another of the one or more photonic network layers, wherein each of the one or more photonic network layers comprises:
a plurality of neurons, wherein each of the plurality of neurons comprises:
a neuron modulator to apply serialized weights to a portion of the input time-modulated signal;
an integrating detector to integrate the input time-modulated signal to provide a scalar signal; and
a travelling-wave resonator connected to the integrating detector; and
a layer waveguide serially connected to the travelling-wave resonators of the plurality of neurons, wherein the travelling-wave resonators serially perform nonlinear activation of the seed light in the layer waveguide based on the scalar signals to generate the output time-modulated signal.

11. The photonic neural network of claim 10, wherein, for at least one of the one or more photonic network layers, timing of the nonlinear activation of the seed light by the travelling-wave resonators is controlled by electronically delaying the scalar signals to the travelling-wave resonators.

12. The photonic neural network of claim 10, wherein, for at least one of the one or more photonic network layers, timing of the nonlinear activation of the seed light by the travelling-wave resonators is controlled by sequentially tuning a resonant wavelength of the travelling-wave resonators to match a wavelength of the seed light in the layer waveguide.

13. The photonic neural network of claim 10, wherein timing of the nonlinear activation of the seed light by the travelling-wave resonators is adjustable to reconfigure at least one of the one or more photonic network layers.

14. The photonic neural network of claim 10, wherein the neuron modulator in at least one of the one or more photonic network layers comprises an electro-optic modulator.

15. The photonic neural network of claim 10, wherein the input modulator comprises an electro-optic modulator.

16. The photonic neural network of claim 10, wherein the integrating detector in at least one of the one or more photonic network layers comprises a photodiode.

17. The photonic neural network of claim 10, wherein the travelling-wave resonator in at least of the plurality of neurons in at least one of the one or more photonic network layers comprises at least one of a ring resonator or a racetrack resonator.

18. The photonic neural network of claim 10, wherein the nonlinear activation corresponds to a nonlinear ReLU (rectified linear unit) activation function.

19. A method comprising:
generating, with one or more photonic network layers, an output time-modulated signal from an input time-modulated signal by:
applying, with a plurality of neuron modulators, serialized weights to portions of the input time-modulated signal;
integrating, with a plurality of integrating detectors, the portions of the input time-modulated signal to generate scalar signals; and
performing, with a plurality of travelling-wave resonators coupled to the plurality of integrating detectors and a layer waveguide, nonlinear activation of seed light in the layer waveguide based on the scalar signals to provide the output time-modulated signal.

20. The method of claim 19, further comprising:
adjusting timing of the nonlinear activation of the seed light by the travelling-wave resonators to reconfigure at least one of the one or more photonic network layers.
